(19) United States
(12) Patent Application Publication
(10) Pub. No.: US 2026/0060409 A1
(43) Pub. Date: Mar. 5, 2026

(54) PORTABLE CUTTING TOOL WITH POCKET CLIP

(71) Applicant: Tienchi Hu, Taipei (TW)

(72) Inventor: Tienchi Hu, Taipei (TW)

(21) Appl. No.: 19/312,695

(22) Filed: Aug. 28, 2025

Related U.S. Application Data
(60) Provisional application No. 63/687,930, filed on Aug. 28, 2024.

(51) Int. Cl. A45F 5/02; B26B 1/02

(52) U.S. Cl. CPC A45F 5/021; B26B 1/02

(57) ABSTRACT

A portable cutting tool with a pocket clip is provided. The portable cutting tool includes a blade structure and a handle structure. The handle structure includes a tail portion having thereon a first hole, a second hole and a third hole on a first lateral surface, a second lateral surface and a third lateral surface of the tail portion, respectively. The pocket clip includes a clip body and a securing member. A first segment of the clip body is selectively inserted into the first hole or the second hole and fixed through the securing member and a securing hole formed on the first segment of the clip body, thereby fixing the clip body to the first lateral surface or the second lateral surface of the tail portion to enable a second segment of the clip body located outside the handle structure to perform a clipping function.

### CROSS-REFERENCE TO RELATED APPLICATIONS

The present application is a nonprovisional application claiming benefit from a prior-filed provisional application bearing a Ser. No. 63/687,930 and filed Aug. 28, 2024, the entity of which is incorporated herein for reference.

### FIELD OF THE INVENTION

The present disclosure relates to a portable cutting tool, and particularly to a portable cutting tool with a tail-mounted pocket clip.

### BACKGROUND OF THE INVENTION

In daily life at home and outdoors, tools having sharp blades such as knives, saws, and the like, are commonly used for conducting a variety of functions including, for example, unboxing, cutting, drilling and scratching. Items such as bags, ropes, paper, food and many other articles can be broken or cut off with such tools. Folding knives or saws are widely used portable cutting tools because they are easy to carry and capable of protecting both the blade and the user.

A pocket clip may be mounted on such a knife, thereby removable attaching the knife to the user's pocket to make it easy to carry and access. This pocket clip typically has a form of an elongated clip. One end of the pocket clip is fixed to the knife handle, while the other end is fixed in spaced relationship to the outer surface of the knife handle so that a gap is defined between the pocket clip and the knife handle to hold and retain a supporting object, such as a pocket edge or a belt of the user.

Different users may be right-handed or left-handed, or may otherwise prefer to carry a folding knife on a particular side or in a particular orientation. Consequently, manufacturers need to produce and sell both right-handed knives and left-handed knives. However, it is not economical to provide both types of knives in view of the required production equipment and possible overstocking of the left-handed tools.

U.S. Pat. No. 5,704,129 entitled “KNIFE WITH REVERSIBLE CLIP” proposed a portable knife with reversible clip to allow the portable knife to be transformed between a right-handed state and a left-handed state. The reversible clip is secured to the knife handle by fastened screws. However, due to the circular shape of the screw holes and insufficient friction between the clip and the knife handle, the clip is prone to rotation relative to the knife handle, which may result in a loss of clipping functionality. Accordingly, the present disclosure develops an improved clip structure to meet requirements of various applications.

### SUMMARY OF THE INVENTION

An aspect of the present disclosure provides a portable cutting tool. The portable cutting tool includes a blade structure and a handle structure connected to each other. The blade structure has a cutting portion. The handle structure includes a grip portion and a tail portion. A connector-receiving structure is provided on the tail portion, and has a first hole, a second hole and a third hole formed on a first lateral surface, a second lateral surface and a third lateral surface of the tail portion, respectively. A pocket clip is coupled to the connector-receiving structure of the tail portion, and includes a clip body and a securing member. A first segment of the clip body is selectively inserted into dither the first hole or the second hole of the connector-receiving structure, and the securing member is inserted into the third hole and passes through a securing hole formed on the first segment of the clip body, thereby fixing the clip body to either the first lateral surface or the second lateral surface of the tail portion to enable a second segment of the clip body located outside the handle structure to perform a clipping function.

Another aspect of the present disclosure provides a portable cutting tool. The portable cutting tool includes a blade structure and a handle structure connected to each other. The blade structure has a cutting portion. The handle structure includes a grip portion and a tail portion. A connector-receiving structure is provided at a bottom of the tail portion, and has a first engagement structure and a first securing hole. A pocket clip is coupled to the connector-receiving structure of the tail portion, and includes a clip body and a securing member. A first segment of the clip body has thereon a second engagement structure. The second engagement structure is in one of a first rotation state and a second rotation state to be engaged with the first engagement structure of the connector-receiving structure, thereby restricting movement of the clip body in a first direction. The securing member passes through a second securing hole of the first segment of the clip body along a second direction and is inserted into the first securing hole to secure the clip body to the tail portion of the handle structure, thereby enabling the second segment of the clip body located outside the handle structure to perform a clipping function with the first lateral surface or the second lateral surface. The first direction is different from the second direction.

A further aspect of the present disclosure provides a portable cutting tool. The portable cutting tool includes a blade structure and a handle structure connected to each other. The blade structure has a cutting portion. The handle structure includes a grip portion and a tail portion. A connector-receiving structure is provided on the tail portion, and has a first hole, a second hole and a third hole formed on a first lateral surface, a second lateral surface and a third lateral surface of the tail portion, respectively. A pocket clip is coupled to the connector-receiving structure of the tail portion, and includes a clip body and a securing member. A first segment of the clip body is selectively inserted into either the first hole or the second hole of the connector-receiving structure. The securing member is inserted into the third hole and engaged with a first engagement structure formed on the first segment of the clip body, thereby fixing the clip body to either the first lateral surface or the second lateral surface of the tail portion to enable a second segment of the clip body located outside the handle structure to perform a clipping function.

### BRIEF DESCRIPTION OF THE DRAWINGS

The advantages of the present disclosure will become more readily apparent to those ordinarily skilled in the art after reviewing the following detailed description and accompanying drawings, in which:

FIGS. 1A and 1B are schematic diagrams illustrating the structure of a portable cutting tool with a pocket clip according to an embodiment of the present disclosure.

FIGS. 2A and 2B are schematic diagrams illustrating the structure of a portable cutting tool with a pocket clip according to another embodiment of the present disclosure.

FIGS. 3A and 3B are schematic diagrams illustrating the structure of a portable cutting tool with a pocket clip according to a further embodiment of the present disclosure.

FIGS. 4A and 4B are schematic diagrams illustrating the structure of a portable cutting tool with a pocket clip according to a further embodiment of the present disclosure.

FIGS. 5A-5C are schematic diagrams illustrating the structure of a portable cutting tool with a pocket clip according to a further embodiment of the present disclosure.

FIGS. 6A-6C are schematic diagrams illustrating the structure of a portable cutting tool with a pocket clip according to a further embodiment of the present disclosure.

FIGS. 7A-7D are schematic diagrams illustrating the structure of a portable cutting tool with a pocket clip according to a further embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed. The figures do not necessarily reflect the actual structure, shape, size or dimension of components being illustrated. Modifications or adjustments of the structure, shape, size or dimension of the components should be covered in the practicable scope of the present disclosure when such changes do not deviate from the concepts of the present disclosure.

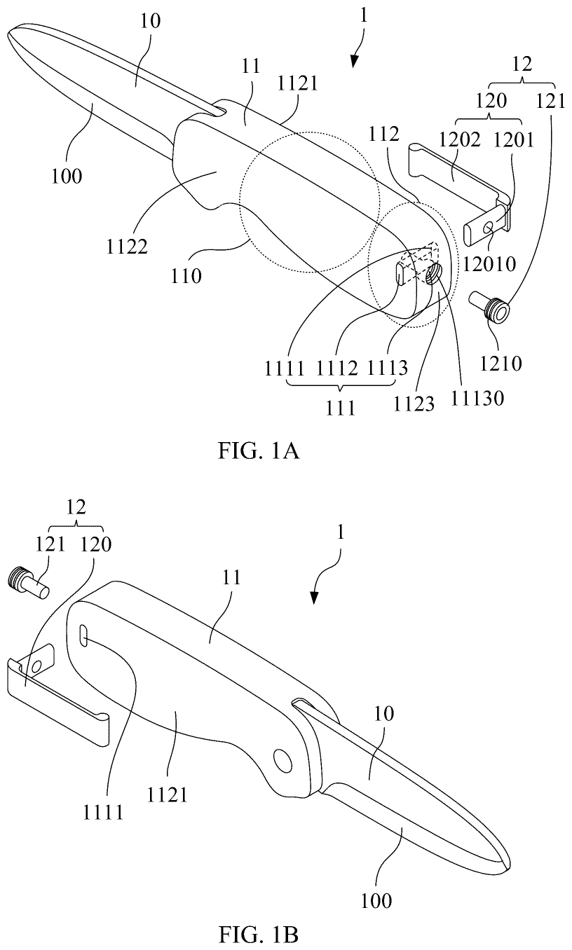

Please refer to FIGS. 1A and 1B, which are schematic diagrams illustrating the structure of a portable cutting tool with a pocket clip according to an embodiment of the present disclosure. The portable cutting tool in this embodiment is exemplified as a folding knife. However, the concepts of the present disclosure may be applied to a folding saw by replacing the knife blade with a toothed saw blade. Similarly, the technical means of the present disclosure are applicable to a wide variety of portable cutting tools having a blade-handle structure, and a detailed description of the variation is omitted herein for the sake of brevity.

FIG. 1A is a schematic diagram showing the appearance and structure of a portable knife 1 in an unfolded state. The portable knife 1 mainly includes a knife blade 10 and a knife handle 11. The knife blade 10 has a cutting portion 100, and the knife handle 11 is pivotally connected to the knife blade 10. In a folded state, the knife blade 10, to be carried or put away, is pivotally rotated to have the cutting portion 100 face toward the knife handle 11. The knife handle 11 includes a grip portion 110 and a tail portion 112. A connector-receiving structure 111 is provided on the tail portion 112 and includes a first hole 1111, a second hole 1112 and a third hole 1113. The first hole 1111, the second hole 1112 and the third hole 113 are formed on a first lateral surface 1121, a second lateral surface 1122 and a third lateral surface 1123 of the tail portion 112, respectively. The third hole 1113 has a depth sufficient to extend to or pass through the first hole 1111 and the second hole 1112. The first hole 1111 and the second hole 1112 may be formed separately. Alternatively, the first hole 1111 and the second hole 1112 may be formed overlappingly to define a through hole, as shown in FIG. 1A.

Instead of pivot connection, the knife blade may slide forward or backward to extend from or retract into the knife handle for storage. Such configurations are also encompassed within the scope of the present disclosure, and detailed description of such known structures is therefore omitted.

In order to attach the portable knife to a pocket of clothing, the present disclosure provides a pocket clip 12 to be coupled to the connector-receiving structure 111 on the tail portion 112 of the knife handle 11. The pocket clip 12 mainly includes a clip body 120 and a securing member 121. The clip body 120 includes a first segment 1201 and a second segment 1202 connected to each other in a substantially orthogonal relationship. After the first segment 1201 of the clip body 120 is selectively inserted into one of the first hole 1111 and the second hole 1112 of the connector-receiving structure 111, the securing member 121 is inserted into the third hole 1113 and passes through a securing hole 12010 of the first segment 1201 of the clip body 120, thereby securing the clip body 120 to either the first lateral surface 1121 or the second lateral surface 1122 of the tail portion 112 of the knife handle 11. In this manner, the second segment 1202 of the clip body 120, disposed externally to the knife handle 11, is enabled to perform the clipping function. Further, the first segment 1201 and the second segment 1202 of the clip body 120 in this embodiment extend at substantially right angles with respect to each other. Therefore, when the first segment 1201 of the clip body 120 is inserted perpendicularly into either the first hole 1111 or the second hole 1112, the extension direction of the second segment 1202 of the clip body 120 is substantially parallel to the first lateral surface 1121 or the second lateral surface 1122. Thus, a gap is defined between the second segment 1202 of the clip body 120 and the first lateral surface 1121 or the second lateral surface 1122 to hold and retain a supporting object, e.g. a pocket or a belt.

In this embodiment, the securing member 121 is a screw component having threads 1210 around the screw head. The threads 1210 of the screw component are configured to mate with the threads 11130 on the inner wall of the third hole 1113. Once the screw component is inserted into and passes through the securing hole 12010 of the first segment 1201 of the clip body 120, the matching threads 1210 and 11130 are engaged with each other so that the clip body 120 is secured to the tail portion 112 of the knife handle 11. Accordingly, the second segment 1202 of the clip body 120 disposed outside the knife handle 11 is enabled to perform the clipping function. More specifically, when the first segment 1201 of the clip body 120 is inserted into the first hole 1111 of the connector-receiving structure 111, the clip body 120 is fixed to the first lateral surface 1121 of the tail portion 112 of the knife handle 11. Conversely, when the first segment 1201 of the clip body 120 is inserted into the second hole 1112 of the connector-receiving structure 111, the clip body 120 is fixed to the second lateral surface 1122 of the tail portion 112 of the knife handle 11. In this manner, the user may selectively switch the position of the clip body 120 between the first lateral surface 1121 or the second lateral surface 1122 of the tail portion 112 of the knife handle 11 as desired by selectively inserting the first segment 1201 of the clip body 120 into the first hole 1111 or the second hole 1112 of the connector-receiving structure 111 as well as loosening or tightening the securing member 121 (e.g. the screw component).

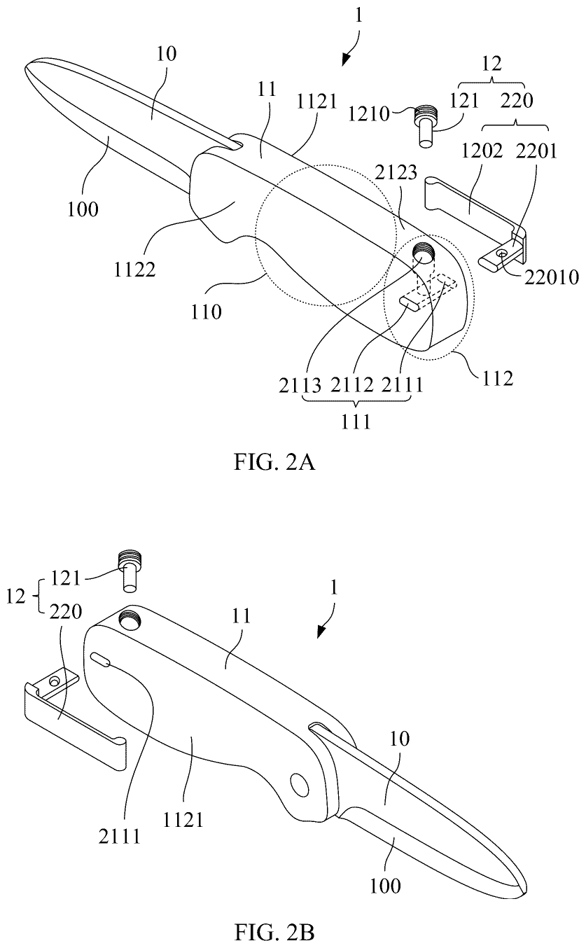

Please refer to FIGS. 2A and 2B, which are schematic diagrams illustrating the structure of a portable cutting tool with a pocket clip according to another embodiment of the present disclosure. The primary difference between the portable knifes with respect to FIGS. 2A-2B and FIGS. 1A-1B is the location of the third lateral surface 2123 where the third hole 2113 is formed. Instead of being located at the bottom side of the tail portion 112 of the knife handle 11, the third lateral surface 2123 is located at the back side of the knife handle 11. The hole orientation of the securing hole 22010 of the first segment 2201 of the clip body 220 is adaptively adjusted, e.g. with approximately 90°, for receiving the securing member 121 inserted into the third hole 2113 at the back side of the tail portion 112 of the knife handle 11. The shapes of the first hole 2111 and the second hole 2112 of the connector-receiving structure 111 are correspondingly modified for receiving the first segment 2201 of the clip body 220. Therefore, the securing member 121 is inserted into the third hole 2113 at the back side of the tail portion 112 of the knife handle 11, and passes through the securing hole 22010 of the first segment 2201 of the clip body 220, so as to fix the clip body 220 to either the first lateral surface 1121 or the second lateral surface 1122 of the tail portion 112 of the knife handle 11. As a result, the second segment 1202 of the clip body 220 on the outside of the knife handle 11 is enabled to perform the clipping function. The structure and function of other components of the portable knife 1 are similar to those as previously described with reference to FIGS. 1A and 1B, and therefore a detailed description thereof is omitted herein. According to the design, it is more difficult to bend the second segment 1202 outwards to break the connection between the first segment 2201 and the second segment 1202 of the clip body 220 so that the clip body 220 has improved structural strength for clipping. The location of the third hole (e.g. at the bottom side or the back side of the tail portion 112 of the knife handle 11) and the aspect ratio of the first hole 2111 and the second hole 2112 may be determined based on the shape and the material strength of the tail portion 112 of the knife handle 11.

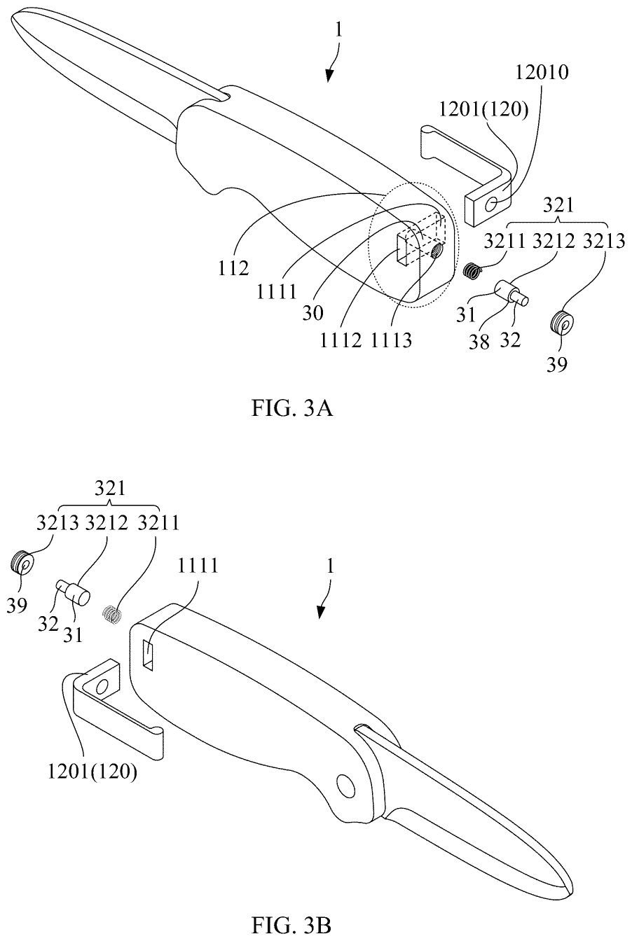

Please refer to FIGS. 3A and 3B, which are schematic diagrams illustrating the structure of a portable cutting tool with a pocket clip according to a further embodiment of the present disclosure. The primary difference between the portable knifes with respect to FIGS. 3A-3B and FIGS. 1A-1B is that the securing member 321 in this embodiment is composed of an elastic component 3211, a movable component 3212 and a securing component 3213. The elastic component 3211 may be implemented as a compression coil spring as shown in FIGS. 3A and 3B or alternatively as other types of spring or elastic body, such as a wave spring, a Belleville washer/disc spring, a gas spring or an elastic rubber pad.

The movable component 3212 includes a first end 31 and a second end 32, and a shoulder structure 38 is formed at the junction between the first end 31 and the second end 32. The movable component 3212 is confined by the securing component 3213 and the elastic component 3211 within the third hole 1113 on the tail portion 112 of the knife handle 11. The third hole 1113 has a depth sufficient to pass through the through hole 30 defined by both the first hole 1111 and the second hole 1112. The clip body 120 could be secured to the tail portion 112 through the following steps. First, the elastic component 3211 is disposed within the third hole 1113 and abuts against a bottom surface of the third hole 1113. Then, the first end 31 of the movable component 3212 is disposed within the third hole 1113 and abuts against the elastic component 3211. Finally, the securing component 3213 is disposed and fixed in the third hole 1113 to complete the securing. The securing component 3213 may be fixed within the third hole 1113 by screwing with mating threads as described above or by direct riveting with a rivet. A pass-through hole 39 is defined in the securing component 3213. The opening of the pass-through hole 39 may have a specific shape such as a hexagon. Thus, the user can use a hexagon key or other corresponding screwdriver to tighten the securing member 3213 within the third hole 1113.

In this embodiment, the first end 31 of the movable component 3212 is a cylindrical structure having a greater diameter than that of the cylindrical structure of the second end 32. The pass-through hole 39 in the securing component 3213 is designed to receive the second end 32 of the movable component 3212 while exposing the top surface of the second end 32. In this manner, when no external force is exerted on the top surface of the second end 32 of the movable component 3212, the first end 31 of the movable component 3212 is urged by the elastic component 3211 toward the securing component 3213. Consequently, the movable component 3212 can pass through the securing hole 12010 of the first segment 1201 of the clip body 120 with its second end 32 and then enter the pass-through hole 39, and is stopped when the shoulder structure 38 touches against the securing component 3213. Similarly, the clip body 120 can also be selectively fixed to either the first lateral surface 1121 or the second lateral surface 1122 of the tail portion 112 of the knife handle 11.

When the user intends to switch the position of the clip body 120, a pen tip or other personal item having a pointed pin could be used to apply force onto the top surface of the second end 32 of the movable component 3212 exposed from the pass-through hole 39 of the securing component 3213, thereby compressing the elastic component 3211 and urging the movable component 3212 toward the bottom surface of the third hole 1113. Once the movable component 3212 is displaced to completely leave the securing hole 12010, the first segment 2201 of the clip body 220 is permitted to slightly slide along the through hole 30 even though the small-sized pen tip remains inserted in the securing hole 12010. After the first segment 1201 of the clip body 120 is moved outward for a short distance and the movable element 3212 is restrained, the pen tip may be removed from the pass-through hole 39. At this time, the first segment 1201 of the clip body 120 is no longer restricted by either the second end 32 of the movable component 3212 or the pen tip. The clip body 120 can be removed from the tail portion 112 of the knife handle 11 and then fixed to the opposite lateral surface.

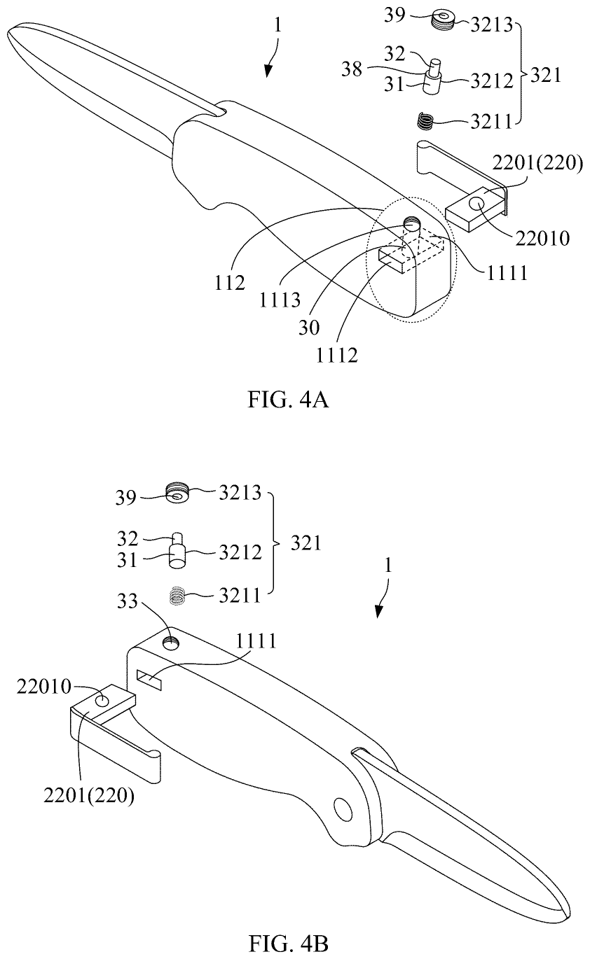

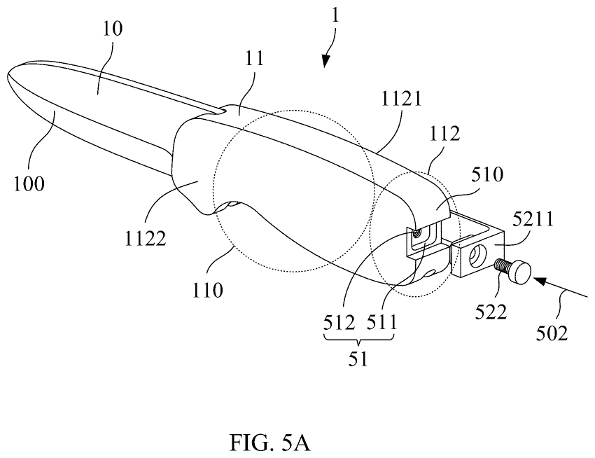

FIGS. 4A and 4B are schematic diagrams illustrating the structure of a portable cutting tool with a pocket clip according to a further embodiment of the present disclosure. The portable knife 1 in this embodiment integrates the features described with reference to FIGS. 2A, 2B, 3A and 3B, involving the modified hole orientation of the securing hole 22010 and the modified structure of the securing member 321. The concepts have been described in the above embodiments and are not repeated herein for brevity. In this embodiment, the position of the clip body 220 can be switched conventionally and the clip body 220 has enhanced strength without adversely affecting the gripping of the portable knife 1.

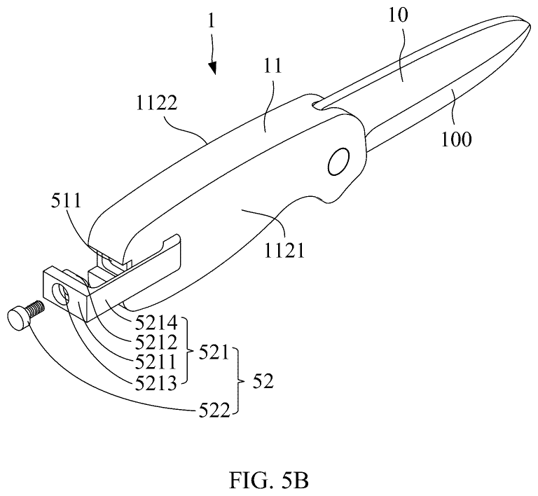

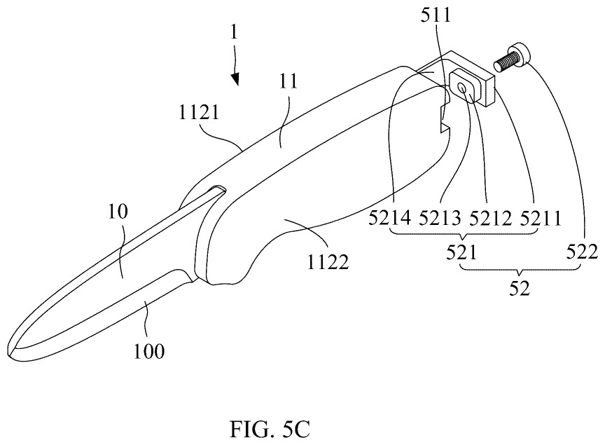

Please refer to FIGS. 5A-5C, which are schematic diagrams illustrating the structure of a portable cutting tool with a pocket clip according to a further embodiment of the present disclosure. As mentioned above, the portable cutting tool in this embodiment is exemplified by a folding knife. The concepts of the present disclosure can be applied to a folding saw by replacing the knife blade with a toothed saw blade. Similarly, the technical means may be widely applied to various portable cutting tools having a blade-handle structure, and a detailed description of the variation is omitted for brevity.

FIGS. 5A-5C are schematic diagrams showing the appearance and structure of a portable knife 1 in an unfolded state from different perspectives. The portable knife 1 mainly includes a knife blade 10 and a knife handle 11. The knife blade 10 has a cutting portion 100, and the knife handle 11 is pivotally connected to the knife blade 10. In a folded state, the knife blade 10, to be carried or put away, is pivotally rotated to have the cutting portion 100 face toward the knife handle 11. The knife handle 11 includes a grip portion 110 and a tail portion 112. A connector-receiving structure 51 is provided at the bottom 510 of the tail portion 112, and includes a first engagement structure 511 and a first securing hole 512. In this embodiment, the first engagement structure 511 is implemented as a rectangular recess having a normal direction parallel to a second direction 502 (i.e. the lengthwise direction of the knife handle 11), and the first securing hole 512 is a screw hole formed at the bottom of the rectangular recess. In addition, the pocket clip 52 coupled to the connector-receiving structure 51 provided on the tail portion 112 of the knife handle 11 includes a clip body 521 and a securing member 522. The clip body 521 includes a first segment 5211 and a second segment 5214 connected to each other in a substantially orthogonal relationship. The first segment 5211 of the clip body 521 has a second engagement structure 5212. In this embodiment, the second engagement structure 5212 is implemented as a rectangular protrusion, having a normal direction parallel to the second direction 502 (i.e. the lengthwise direction of the knife handle 11), to be fit within the rectangular recess of the first engagement structure 511. The second engagement structure 5212 in either a first rotation state or a second rotation state can be engaged with the first engagement structure 511 of the connector-receiving structure 51, thereby restricting the movement of the clip body 521 in a first direction. The securing member 522 can pass through a second securing hole 5213 of the first segment 5211 of the clip body 521 along the second direction 502 and is inserted into the first securing hole 512, wherein the first direction is different from the second direction. In this embodiment, the securing member 522 is a screw component having a threaded shank. The threads of the screw component mate with the threads on the inner wall of the first securing hole 512, and the mating threads can be engaged and locked with each other. The first direction is perpendicular to the second direction. There is a rotation angle of 180° between the first rotation state and the second rotation state of the clip body 521 rotating about the second direction 502. In this manner, the clip body 521 may be selectively fixed to either the first lateral surface 1121 or the second lateral surface 1122 of the tail portion 112 of the knife handle 11 as desired. After the assembly, the second segment 5214 of the clip body 521 is enabled to perform the clipping function.

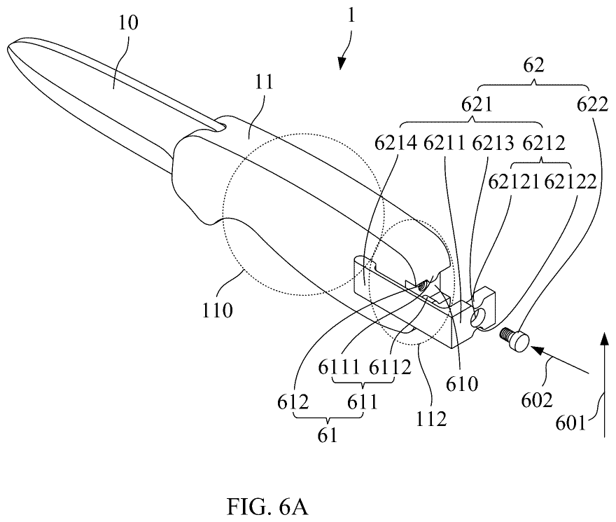

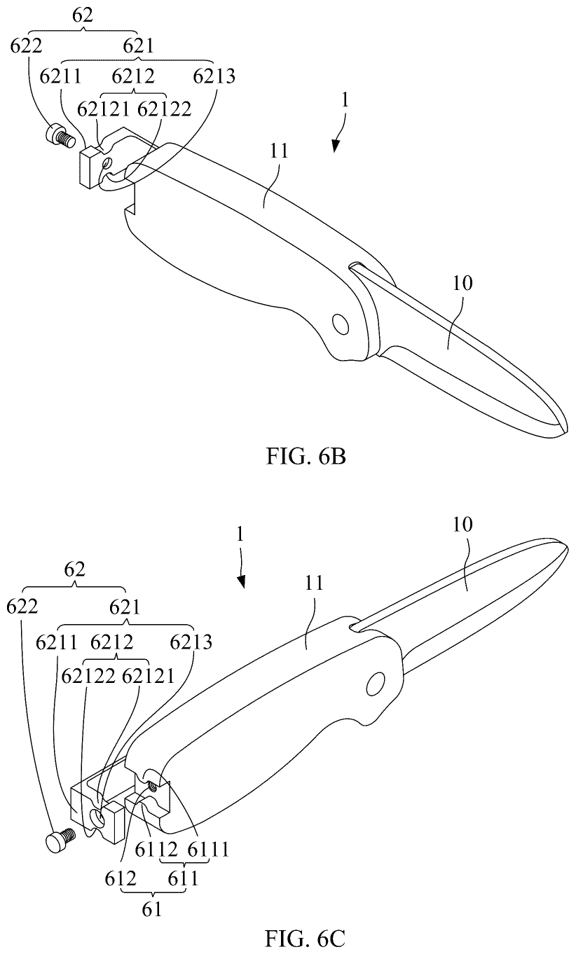

Please refer to FIGS. 6A-6C, which are schematic diagrams illustrating the structure of a portable cutting tool with a pocket clip according to a further embodiment of the present disclosure. FIGS. 6A-6C are schematic diagrams showing the appearance and structure of a portable knife 1 in an unfolded state from different perspectives. The portable knife 1 also includes a knife blade 10 and a knife handle 11. The knife handle 11 includes a grip portion 110 and a tail portion 112. A connector-receiving structure 61 is provided at the bottom 610 of the tail portion 112 of the knife handle 11, and includes a first engagement structure 611 and a first securing hole 612. In addition, the pocket clip 62 coupled to the connector-receiving structure 61 provided on the tail portion 112 of the knife handle 11 also includes a clip body 621 and a securing member 622. The clip body 621 includes a first segment 6211 and a second segment 6214 connected to each other in a substantially orthogonal relationship. The first segment 6211 of the clip body 621 has a second engagement structure 6212. Compared to the coupling structure in FIGS. 5A-5C, the first engagement structure 611 in this embodiment includes two protrusions 6111 and 6112 protruding along a first direction 601 (e.g. the widthwise direction of the knife blade 10) and facing toward each other. Corresponding to the first engagement structure 611, the second engagement structure 6212 of the first segment 6211 has two recesses 62121 and 62122 recessed along the first direction 601. The first securing hole 612 is also a screw hole formed at the bottom 610 of the first engagement structure 61. Therefore, the two recesses 62121 and 62122 of the second engagement structure 6212 can be engaged with the two protrusions 6111 and 6112 of the first engagement structure 611. The second engagement structure 6212 in one of a first rotation state and a second rotation state can be engaged with the first engagement structure 611 in the connector-receiving structure 61, thereby restricting the movement of the clip body 621 in the first direction. The securing member 622 can pass through a second securing hole 6213 of the first segment 6211 of the clip body 621 along a second direction 602 (i.e. the lengthwise direction of the knife handle 11) and enter the first securing hole 612, wherein the first direction is different from the second direction. In this embodiment, the securing member 622 is a screw component having a threaded shank. The threads of the screw component fit the threads on the inner wall of the first securing hole 612 (i.e. the screw hole), and the mating threads can be engaged and locked with each other. The first direction is perpendicular to the second direction. There is a rotation angle of 180° between the first rotation state and the second rotation state of the clip body 621 rotating about the second direction 602. In this manner, the clip body 621 can be selectively fixed to the first lateral surface 1121 or the second lateral surface 1122 of the tail portion 112 of the knife handle 11 as desired. After the assembly, the second segment 6214 of the clip body 621 is enabled to perform the clipping function.

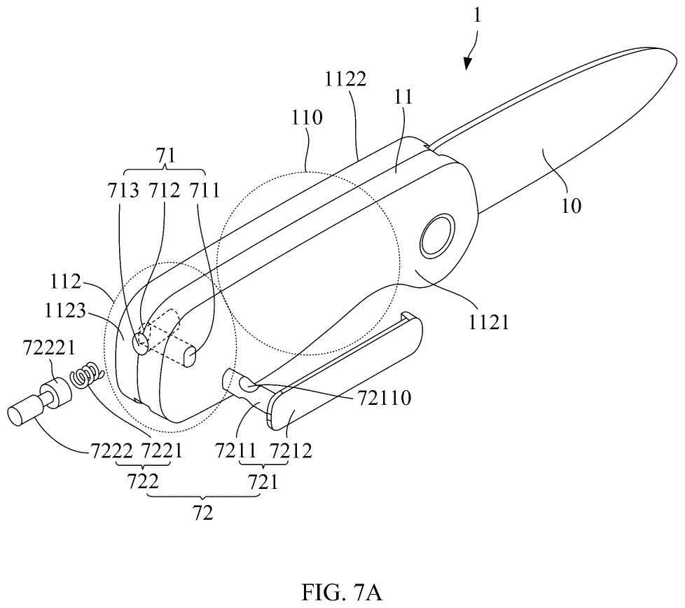

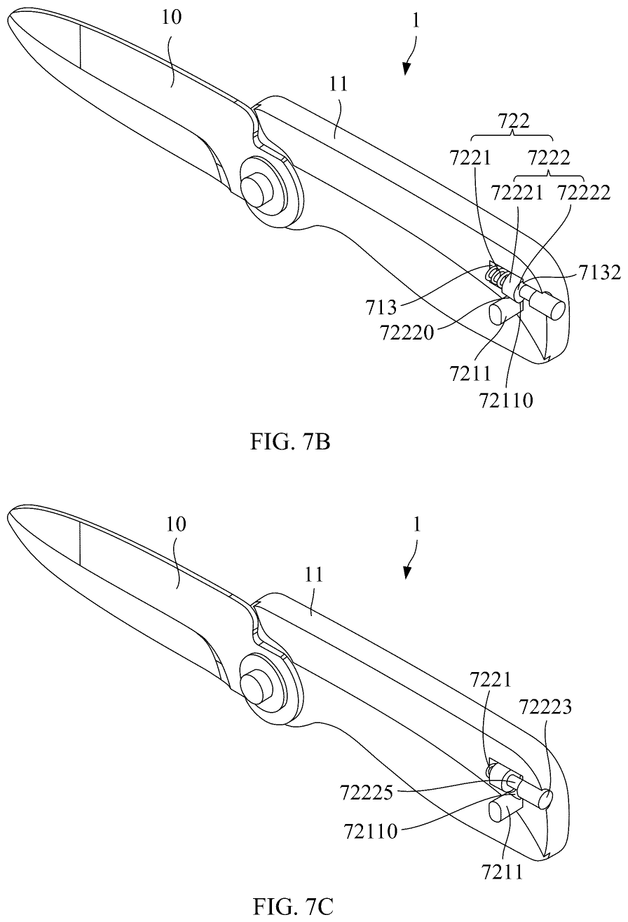

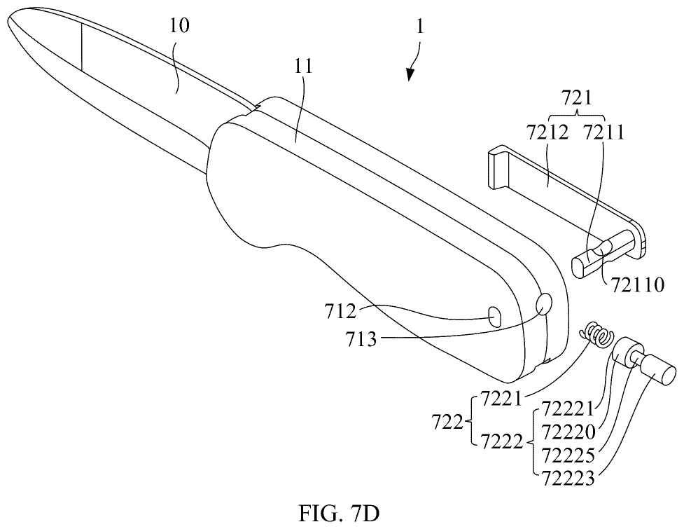

FIGS. 7A-7D are schematic diagrams illustrating the structure of a portable cutting tool with a pocket clip according to a further embodiment of the present disclosure. FIGS. 7A-7D are schematic diagrams showing the appearance and structure of a portable knife 1 in an unfolded state from different perspectives before and after assembly. As shown in FIGS. 7A and 7D, the portable knife 1 also includes a knife blade 10 and a knife handle 11. The knife handle 11 includes a grip portion 110 and a tail portion 112. A connector-receiving structure 71 is provided on the tail portion 112, and includes a first hole 711, a second hole 712 and a third hole 713. The first hole 711 and the second hole 712, respectively formed on a first lateral surface 1121 and a second lateral surface 1122 of the tail portion 112 of the knife handle 11, have elliptical openings or non-circular elongated openings. The third hole 713 is formed on a third lateral surface 1123 of the tail portion 112 of the knife handle 11.

In addition, the pocket clip 72 coupled to the connector-receiving structure 71 provided on the tail portion 112 of the knife handle 11 includes a clip body 721 and a securing member 722. The clip body 721 includes a first segment 7211 and a second segment 7212 connected to each other in a substantially orthogonal relationship. When the first segment 7211 of the clip body 721 is inserted into either the first hole 711 or the second hole 712, the elliptical or non-circular elongate opening of the first hole 711 or the second hole 712 restricts the rotation of the clip body 721. After the first segment 7211 of the clip body 721 is selectively inserted into one of the first hole 711 and the second hole 712 of the connector-receiving structure 71, the securing member 722 is inserted into the third hole 713 and engaged with a first engagement structure 72110 of the first segment 7211 of the clip body 721, thereby fixing the clip body 721 to either the first lateral surface 1121 or the second lateral surface 1122 of the tail portion 112 of the knife handle 11. In this manner, the second segment 7212 of the clip body 721 located outside the knife handle 11 is enabled to perform the clipping function. Further, the first segment 7211 and the second segment 7212 of the clip body 721 in this embodiment extend at substantially right angles with respect to each other. Therefore, when the first segment 7211 of the clip body 721 is inserted perpendicularly into either the first hole 711 or the second hole 712, the extension direction of the second segment 7212 of the clip body 721 is substantially parallel to the first lateral surface 1121 or the second lateral surface 1122. Accordingly, a gap is defined between the second segment 7212 of the clip body 721 and the first lateral surface 1121 or the second lateral surface 1122 to hold and retain a supporting object.

In this embodiment, the securing member 722 is primarily composed of an elastic component 7221 and a movable component 7222. The elastic component 7221 may be implemented as a compression coil spring as shown in FIGS. 7A-7D or alternatively as other types of spring or elastic body, such as a wave spring, a Belleville washer/disc spring, a gas spring or an elastic rubber pad. The elastic component 7221 and the movable component 7222 are disposed within the third hole 713 formed on the tail portion 112 of the knife handle 11. The elastic component 7221 is disposed within the third hole 713 and abuts against the bottom surface of the third hole 713. The elastic component 7221 includes a first end 72221, a second end 72223 and a rod portion 72225 connected between the first end 72221 and the second end 72223. A shoulder structure 72222 is formed at the junction between the first end 72221 and the rod portion 72225. The first end 72221 of the movable component 7222 is disposed within the third hole 713 and abuts against the elastic component 7221.

Please refer to the FIG. 7B, in which a half of the knife handle 11 is not shown. It is shown that no external force is exerted on the movable component 7222, and the movable component 7222 protrudes from the third hole 713. The movable component 7222 is urged by the restoring force of the elastic component 7221 from one side. On the other hand, a neck structure 7132 in the third hole 713 restrains the shoulder structure 72222 of the movable component 7222 from the opposite side. A second engagement structure 72220 of the movable component 7222 is engaged with the first engagement structure 72110 of the first segment 7211 of the clip body 721 inserted into the first hole 711 or the second hole 712 of the connector-receiving structure 71. The first engagement structure 72110 may be implemented as a notch for receiving the second engagement structure 72220 to form tight engagement, thereby fixing the clip body 721 to either the first lateral surface 1121 or the second lateral surface 1122 of the tail portion 112 of the knife handle 11. The second segment 7212 of the clip body 721 located outside the knife handle 11 is enabled to perform the clipping function.

Please refer to FIG. 7C, in which a half of the knife handle 11 is not shown. It is shown that the second end 72223 of the movable component 7222 is pressed down in the third hole 713 due to an external force. The external force exerted on the movable component 7222 overcomes the restoring force of the elastic component 7221 and makes the elastic component 7221 compressed, so that the second engagement structure 72220 of the movable component 7222 leaves the first engagement structure 72110 of the first segment 7211 of the clip body 721. At this time, the rod portion 72225 with a smaller diameter than the second engagement structure 72220 does not touch the first engagement structure 72110 to restrict the movement of the first segment 7211 of the clip body 721. A clearance is formed between the rod portion 72225 and the first engagement structure 72110 of the first segment 7211 of the clip body 721. Therefore, the first segment 7211 of the clip body 721 is can be withdrawn from the first hole 711 or the second hole 712. In this manner, repositioning of the clip body 721 between different lateral surfaces can be achieved without the any tool.

It should be understood that the features described in different embodiments may be selectively combined or modified to provide the portable cutting tool of the present disclosure. The various applications can be derived from the above descriptions without the need for further particulars.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable cutting tool, comprising:
a blade structure having a cutting portion;
a handle structure connected to the blade structure and comprising a grip portion and a tail portion, a connector-receiving structure being provided on the tail portion and having a first hole, a second hole and a third hole formed on a first lateral surface, a second lateral surface and a third lateral surface of the tail portion, respectively; and
a pocket clip coupled to the connector-receiving structure of the tail portion and comprising a clip body and a securing member, wherein a first segment of the clip body is selectively inserted into the first hole or the second hole of the connector-receiving structure, and the securing member is inserted into the third hole and passes through a securing hole formed on the first segment of the clip body, thereby fixing the clip body to the first lateral surface or the second lateral surface of the tail portion to enable a second segment of the clip body located outside the handle structure to perform a clipping function.

2. The portable cutting tool according to claim 1, wherein the third lateral surface is located at a bottom side or a back side of the tail portion, and the first segment and the second segment of the clip body are connected to each other in a substantially orthogonal relationship, wherein
when the first segment of the clip body is inserted perpendicularly into the first hole or the second hole, an extension direction of the second segment of the clip body is substantially parallel to the first lateral surface or the second lateral surface, and
a gap is defined between the second segment of the clip body and the first lateral surface or the second lateral surface to hold a supporting object.

3. The portable cutting tool according to claim 1, wherein
the securing member comprises a screw component inserted into the third hole and passing through the securing hole of the first segment of the clip body,
the screw component has first threads matching second threads formed on an inner wall of the third hole, and
when the screw component is secured in the third hole with the first threads and the second threads, the clip body is fixed to the first lateral surface or the second lateral surface of the tail portion, and the second segment located outside the handle structure is enabled to perform the clipping function.

4. The portable cutting tool according to claim 1, wherein the securing member comprises an elastic component, a movable component and a securing component, wherein
the movable component is confined by the securing component and the elastic component within the third hole on the tail portion,
the first hole and the second hole form a through hole, and the third hole reaches the through hole,
the elastic component is disposed within the third hole and abuts against a bottom surface of the third hole,
a first end of the movable component is disposed within the third hole and abuts against the elastic component, and
the securing component is inserted into and secured in the third hole.

5. The portable cutting tool according to claim 4, wherein the elastic component is implemented as one of a compression coil spring, a wave spring, a disc spring, a gas spring and an elastic rubber pad, and the securing component is secured in the third hole through screwing or riveting.

6. The portable cutting tool according to claim 4, wherein
the first end of the movable component is a first cylindrical structure and a second end of the movable component is a second cylindrical structure, wherein the first cylindrical structure has a diameter greater than the second cylindrical structure,
a pass-through hole is formed on the securing component to accommodate the second end of the movable component and expose a top surface of the second end, and
without an external force exerted on the top surface of the second end of the movable component, the first end of the movable component is urged by the elastic component toward the securing component, and the second end of the movable component passes through the securing hole of the first segment of the clip body and abuts against the securing component, thereby fixing the clip body to the first lateral surface or the second lateral surface of the tail portion of the handle structure.

7. A portable cutting tool, comprising:
a blade structure having a cutting portion;
a handle structure connected to the blade structure and comprising a grip portion and a tail portion, a connector-receiving structure being provided at a bottom of the tail portion and having a first engagement structure and a first securing hole; and
a pocket clip coupled to the connector-receiving structure of the tail portion and comprising a clip body and a securing member, a first segment of the clip body having thereon a second engagement structure, wherein
the second engagement structure is in one of a first rotation state and a second rotation state to be engaged with the first engagement structure of the connector-receiving structure, thereby restricting movement of the clip body in a first direction, and
the securing member passes through a second securing hole of the first segment of the clip body along a second direction and is inserted into the first securing hole to secure the clip body to the tail portion of the handle structure, thereby enabling the second segment of the clip body located outside the handle structure to perform a clipping function with the first lateral surface or the second lateral surface wherein the first direction is different from the second direction.

8. The portable cutting tool according to claim 7, wherein
the first engagement structure is a rectangular recess having a normal direction parallel to the second direction,
the first securing hole is a screw hole formed at a bottom of the rectangular recess,
the second engagement structure is a rectangular protrusion, having a normal direction parallel to the second direction, to be fit in the rectangular recess of the first engagement structure,
the second engagement structure is in one of the first rotation state and the second rotation state to be engaged with the first engagement structure of the connector-receiving structure, thereby restricting the movement of the clip body in the first direction, wherein there is a rotation angle of 180° between the first rotation state and the second rotation state of the second engagement structure of the clip body rotating about the second direction,
the securing member is a screw component passing through the second securing hole of the first segment of the clip body along the second direction and being inserted into the screw hole wherein the first direction is different from the second direction, and
the screw component has first threads matching second threads formed on an inner wall of the screw hole.

9. The portable cutting tool according to claim 7, wherein
the first engagement structure comprises at least one protrusion protruding along the first direction,
the first securing hole is a screw hole formed on the tail portion of the handle structure,
the second engagement structure comprises at least one recess recessed along the first direction wherein the recess fits the protrusion,
the second engagement structure is in one of the first rotation state and the second rotation state to be engaged with the first engagement structure of the connector-receiving structure, thereby restricting the movement of the clip body in the first direction, wherein there is a rotation angle of 180° between the first rotation state and the second rotation state of the second engagement structure of the clip body rotating about the second direction,
the securing member is a screw component passing through the second securing hole of the first segment of the clip body along the second direction and being inserted into the screw hole wherein the first direction is perpendicular to the second direction, and
the screw component has first threads matching second threads formed on an inner wall of the screw hole.

10. A portable cutting tool, comprising:
a blade structure having a cutting portion;
a handle structure connected to the blade structure and comprising a grip portion and a tail portion, a connector-receiving structure being provided on the tail portion and having a first hole, a second hole and a third hole formed on a first lateral surface, a second lateral surface and a third lateral surface of the tail portion, respectively; and
a pocket clip coupled to the connector-receiving structure of the tail portion and comprising a clip body and a securing member, wherein a first segment of the clip body is selectively inserted into the first hole or the second hole of the connector-receiving structure,
wherein the securing member is inserted into the third hole and engaged with a first engagement structure formed on the first segment of the clip body, thereby fixing the clip body to the first lateral surface or the second lateral surface of the tail portion to enable a second segment of the clip body located outside the handle structure to perform a clipping function.

11. The portable cutting tool according to claim 10, wherein the third lateral surface is located at a bottom side or a back side of the tail portion, and the first segment and the second segment of the clip body are connected to each other in a substantially orthogonal relationship, wherein
when the first segment of the clip body is inserted perpendicularly into the first hole or the second hole, an extension direction of the second segment of the clip body is substantially parallel to the first lateral surface or the second lateral surface, and
a gap is defined between the second segment of the clip body and the first lateral surface or the second lateral surface to hold a supporting object.

12. The portable cutting tool according to claim 10, wherein
the securing member comprises an elastic component, a movable component and a securing component,
the movable component and the elastic component are disposed within the third hole on the tail portion of the handle structure,
the elastic component abuts against a bottom surface of the third hole, and
the movable component comprises a first end, a second end and a rod portion connected between the first end and the second end, wherein the first end abuts against the elastic component.

13. The portable cutting tool according to claim 12, wherein without an external force exerted on the second end of the movable component,
the movable component is urged by a restoring force of the elastic component,
a neck structure in the third hole restrains a shoulder structure of the movable component,
a second engagement structure of the movable component is engaged with the first engagement structure of the first segment inserted into the first hole or the second hole of the connector-receiving structure,
the first engagement structure is a notch for receiving the second engagement structure, thereby fixing the clip body to the first lateral surface or the second lateral surface of the tail portion of the handle structure to enable the second segment of the clip body located outside the handle structure to perform the clipping function.

14. The portable cutting tool according to claim 13, wherein when an external force is exerted on a second end of the movable component,
the external force overcomes the restoring force of the elastic component and makes the elastic component compressed, so that the second engagement structure of the movable component leaves the first engagement structure of the first segment of the clip body, and
a clearance is formed between the rod portion of the movable component and the first engagement structure of the first segment of the clip body, thereby allowing the first segment of the clip body to be withdrawn from the first hole or the second hole.
